(19) United States
(12) Patent Application Publication
(10) Pub. No.: US 2021/0345153 A1
(43) Pub. Date: Nov. 4, 2021

(54) MEASUREMENT METHOD AND DEVICE

(71) Applicant: VIVO MOBILE COMMUNICATION CO., LTD., Dongguan (CN)

(72) Inventors: Boubacar KIMBA DIT ADAMOU, Dongguan (CN); Xiaodong YANG, Dongguan (CN)

(21) Appl. No.: 17/378,659

(22) Filed: Jul. 17, 2021

Related U.S. Application Data
(63) Continuation of application No. PCT/CN2020/072698, filed on Jan. 17, 2020.

(30) Foreign Application Priority Data
Jan. 18, 2019 (CN) 201910108526.4

(51) Int. Cl. H04W 24/10; H04W 24/08; H04W 76/20

(52) U.S. Cl. CPC H04W 24/10; H04W 76/20; H04W 24/08

(57) ABSTRACT

The present disclosure provides a measurement method and a device. The method includes: receiving configuration information for MDT; receiving an instruction for activating MDT recording when in an idle state or inactive state; and performing MDT measurement based on the configuration information and the instruction for activating MDT recording, and recording a measurement result.

### CROSS-REFERENCE TO RELATED APPLICATIONS

This application is a bypass continuation of PCT Application No. PCT/CN2020/072698 filed Jan. 17, 2020, which claims priority to Chinese Patent Application No. 201910108526.4 filed in China on Jan. 18, 2019, both of which are incorporated herein by reference in their entireties.

### TECHNICAL FIELD

The present disclosure relates to the field of communications technologies, and specifically, to a measurement method and a device.

### BACKGROUND

Technical studies on minimization of drive-test (MDT) are proposed for Long Term Evolution (LTE) networks of the 4th generation mobile communication technology (4G). MDT refers to a technology that is used by a communications system to automatically collect and analyze terminal measurement reports containing location information, and is used to reduce the workload of manual drive tests to the greatest extent.

When a terminal is in an idle state or inactive state, a network cannot activate the terminal to perform MDT measurement.

### SUMMARY

An objective of embodiments of the present disclosure is to provide a measurement method and a device, to resolve the following problem: When a terminal is in an idle state or inactive state, a network cannot activate the terminal to perform MDT measurement.

According to a first aspect of the embodiments of the present disclosure, a measurement method is provided, and applied to a terminal, where the method includes: receiving configuration information for MDT; receiving an instruction for activating MDT recording when the terminal is in an idle state or inactive state; and performing MDT measurement based on the configuration information and the instruction for activating MDT recording, and recording a measurement result.

According to a second aspect of the embodiments of the present disclosure, a terminal is further provided, including: a first receiving module, configured to receive configuration information for MDT; a second receiving module, configured to receive an instruction for activating MDT recording when the terminal is in an idle state or inactive state; and a measurement module, configured to perform MDT measurement based on the configuration information and the instruction for activating MDT recording, and record a measurement result.

According to a third aspect of the embodiments of the present disclosure, a terminal is further provided, including: a processor, a memory, and a program that is stored in the memory and that can run on the processor. When the program is executed by the processor, the steps of the measurement method according to the first aspect are implemented.

According to a fourth aspect of the embodiments of the present disclosure, a computer-readable storage medium is further provided. The computer-readable storage medium stores a computer program. When the computer program is executed by a processor, the steps of the measurement method according to the first aspect are implemented.

According to the embodiments of the present disclosure, it can be ensured that the network activates the terminal that is in the idle state or inactive state to perform MDT measurement.

### BRIEF DESCRIPTION OF DRAWINGS

It becomes clear for a person skilled in the art to learn various other advantages and benefits by reading detailed description of the following preferred implementation manners. Accompanying drawings are merely used for showing the preferred implementation manners, but not considered as a limitation on the present disclosure. In all accompanying drawings, a same reference symbol is used to indicate a same part. In the accompanying drawings:

FIG. 1 is a schematic architectural diagram of a wireless communications system according to an embodiment of the present disclosure;

FIG. 2 is a flowchart of a measurement method according to an embodiment of the present disclosure;

FIG. 3 is another flowchart of a measurement method according to an embodiment of the present disclosure;

FIG. 4 is still another flowchart of a measurement method according to an embodiment of the present disclosure;

FIG. 5 is a structural diagram of a terminal according to an embodiment of the present disclosure; and

FIG. 6 is another structural diagram of a terminal according to an embodiment of the present disclosure.

### DETAILED DESCRIPTION

The following clearly describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

The term “include” and any other variants in the specification and claims of this application are intended to cover a non-exclusive inclusion, for example, a process, method, system, product, or device that includes a list of steps or units is not necessarily limited to those expressly listed steps or units, but may include other steps or units not expressly listed or inherent to such a process, method, product, or device. In addition, “and/or” used in the specification and claims means at least one of the connected objects. For example, A and/or B represents the following three cases: Only A exists, only B exists, and both A and B exist.

In the embodiments of this disclosure, the term such as “exemplary” or “for example” is used to represent an example, an instance, or an illustration. Any embodiment or design scheme described as “exemplary” or “for example” in the embodiments of the present disclosure should not be construed as being more preferred or advantageous than other embodiments or design schemes. To be precise, the use of the term such as “exemplary” or “for example” is intended to present a related concept in a specific manner.

The technology described in this specification is not limited to the 5th-generation (5G) system and subsequent evolved communication systems as well as LTE/LTE-advanced (LTE-A) systems, and can also be applied to various wireless communication systems such as code division multiple access (CDMA), time division multiple access (TDMA), frequency division multiple access (FDMA), orthogonal frequency division multiple access (OFDMA), and single-carrier frequency-division multiple access (SC-FDMA) systems, and other systems.

The terms “system” and “network” are usually used interchangeably. The CDMA system can implement radio technologies such as CDMA2000 and universal terrestrial radio access (UTRA). UTRA includes wideband CDMA (WCDMA) and another CDMA variation. A TDMA system can implement radio technologies such as the global system for mobile communications (GSM). The OFDMA system can implement radio technologies such as ultra mobile broadband (UMB), evolved UTRA (E-UTRA), IEEE 802.11 (Wi-Fi), IEEE 802.16 (WiMAX), IEEE 802.20, and Flash-orthogonal frequency-division multiplexing (OFDM). UTRA and E-UTRA are parts of a universal mobile telecommunications system (UMTS). LTE and advanced LTE (for example, LTE-A) are new UMTS versions that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The technology described herein can be used in the above-mentioned systems and radio technologies as well as other systems and radio technologies.

For ease of understanding the embodiments of the present disclosure, the following technical points are described:

1. About MDT

(1) MDT Mode

MDT measurement includes two modes: logged MDT and immediate MDT.

(2) Terminal Measurement Configuration

It may be independent of the network for recording target configuration MDT for a terminal, and is a configuration for measuring normal radio resource management (RRM). However, in most cases, the availability of measurement results depends conditionally on the terminal RRM configuration.

(3) Terminal Measurement Collection and Reporting

MDT measurement records include multiple events and measurements over time. Time interval measurement collection and reporting are decoupled to limit the impact on terminal battery consumption and network signaling load.

(4) Geographical Range of Measurement Records

The geographic area of defined measurement sets can be collected or configured.

(5) Location Information

Measurement should be associated with available location information and/or other information or measured values, which can be used to derive location information.

(6) Time Information

A measured value in a measurement record should be associated with a time stamp.

(7) Terminal Capability Information

A network can use the terminal capability to select a terminal for MDT measurement.

2. MDT Process in the Related Art

(1) Logged MDT

When a terminal is in an idle state, the terminal performs MDT measurement based on configuration information for MDT delivered by a network and saves recorded content. When the terminal enters a connected state, the terminal indicates to the network that the terminal has MDT data and reports the MDT data to a base station.

(2) Immediate MDT

The terminal performs MDT measurement in the connected state and reports MDT data to the base station immediately.

After receiving the MDT data reported by the terminal, the base station can feed it back to the operation administration and maintenance (OAM) node or other nodes that collect the MDT data.

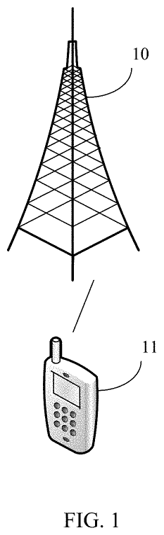

The embodiments of the present disclosure are described below with reference to the accompanying drawings. A measurement method and a device provided in the embodiments of the present disclosure can be applied to a wireless communications system. FIG. 1 is a schematic architectural diagram of a wireless communications system according to an embodiment of the present disclosure. As shown in FIG. 1, the wireless communications system may include: a network device 10 and a terminal. The terminal is denoted as user equipment (UE) 11, and the UE 11 may communicate (transmit signaling or data) with the network device 10. In actual application, a connection between the devices is a wireless connection. For ease of visually indicating a connection relationship between the devices, solid lines are used for illustration in FIG. 1. It should be noted that the communications system may include a plurality of UE 11, and the network device 10 may communicate with the plurality of UE 11.

The terminal provided in this embodiment of the present disclosure can be a mobile phone, a tablet computer, a laptop, an ultra-mobile personal computer (UMPC), a netbook, or personal digital assistant (PDA), a mobile Internet device (MID), a wearable device, an in-vehicle device, or the like.

The network device 10 provided in this embodiment of the present disclosure may be a base station, and the base station may be a commonly used base station, or may be an evolved nodeB (eNB), or may be a device such as a network device (for example, a next generation nodeB (next generation node base station, gNB) or a transmission and reception point (TRP)) in a 5G system.

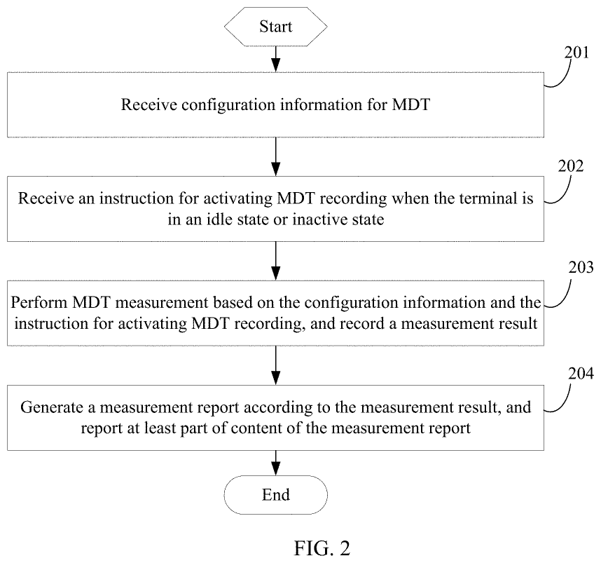

Referring to FIG. 2, an embodiment of the present disclosure provides a measurement method. The method can be performed by a terminal, and includes steps 201 to 204.

Step 201: Receive configuration information for MDT.

For example, receive the configuration information for MDT when the terminal is in a connected state or inactive state.

Optionally, the configuration information may include one or more of the following:

(1) a measurement area parameter;

(2) to-be-recorded measurement record content; and

(3) a measurement timer.

It may be understood that, a timing length of the measurement timer may be configured based on a specific situation, and is not limited in this embodiment of the present disclosure.

Optionally, the measurement area parameter may include one or more of the following:

(1) a network slice list (slice list);

(2) a radio access network paging area (RAN paging area);

(3) a RAN notification area;

(4) a RAN location area;

(5) a system message effective area (System information area); and

(6) information about a network cell, for example, a physical cell identifier (PCI) of the cell.

Optionally, the measurement record content may include one or more of the following:

(1) a reference signal received power (RSRP) value of a synchronization signal and physical broadcast channel (PBCH) block (Synchronization Signal and PBCH block, SS block);

(2) a reference signal received quality (RSRQ) value of the SS block;

(3) a signal to interference plus noise ratio (Signal to Interference plus Noise Ratio, SINR) value of the SS block;

(4) a measurement result of a primary synchronization signal (PSS) of the SS block;

(5) a measurement result of a secondary synchronization signal (SSS) of the SS block;

(6) a measurement result of a PBCH of the SS block;

(7) an RSRP value of a channel state information reference signal (CSI-RS);

(8) an RSRQ value of the CSI-RS;

(9) an SINR value of the CSI-RS;

(10) a measurement result of a tracking RS (TRS); and

(11) a measurement result of a phase-tracking RS (PTRS).

Further, optionally, the measurement result of the PSS or the measurement result of the SSS includes a beam time index.

Further, optionally, the measurement result of the PBCH may include one or more of the following: a measurement result of a demodulation reference signal (DMRS); and beam information related to the DMRS.

Step 202: Receive an instruction for activating MDT recording when the terminal is in an idle state or inactive state.

Optionally, when the terminal is in an idle state or inactive state, receive an instruction for activating MDT recording. Further, receive system information or a broadcast message, where the system information or broadcast message includes the instruction for activating MDT recording. For example, the system information or broadcast message includes one bit (bit), and the one bit is used to indicate the instruction for activating MDT recording.

Step 203: Perform MDT measurement based on the configuration information and the instruction for activating MDT recording, and record a measurement result.

In another embodiment of the present disclosure, after step 203, MDT recording can be stopped based on a preset condition. Optionally, the method may further include: stopping MDT measurement if the measurement timer expires; stopping MDT measurement if the terminal enters the connected state; and stopping MDT measurement and stopping the measurement timer if the terminal enters the connected state.

Step 204: Generate a measurement report according to the measurement result, and report at least part of content of the measurement report.

For example, when the terminal enters the connected state, if the terminal has a measurement report, the terminal may indicate the measurement report to a network. After receiving an instruction from the terminal, the network can determine to make the terminal report the measurement report.

Specifically, send first information to a network node when the terminal enters the connected state, where the first information is used to indicate that the terminal has the measurement report; receive second information from the network node, where the second information is used to instruct the terminal to report at least part of the content of the measurement report; and report at least part of the content of the measurement report to the network node according to the second information.

It may be understood that step 203 is optional.

According to this embodiment of the present disclosure, it can be ensured that the network activates the terminal that is in the idle state or inactive state to perform MDT measurement.

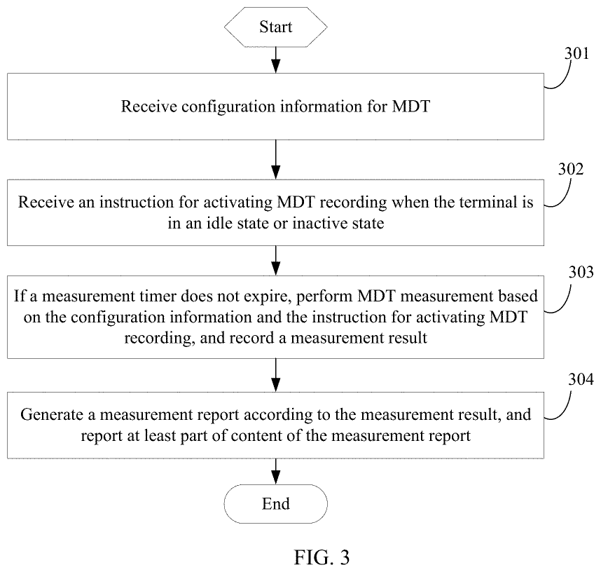

Referring to FIG. 3, an embodiment of the present disclosure provides a measurement method. The method can be performed by a terminal, and the method includes steps 301 to 304.

Step 301: Receive configuration information for MDT.

It should be noted that for descriptions of step 301, refer to the descriptions of step 201.

Step 302: Receive an instruction for activating MDT recording when the terminal is in an idle state or inactive state.

It should be noted that for descriptions of step 302, refer to the descriptions of step 202.

Step 303: If a measurement timer does not expire, perform MDT measurement based on the configuration information and the instruction for activating MDT recording, and record a measurement result.

Further, a starting time of the measurement timer may be at least one of the following:

(1) a time when the configuration information is received;

(2) a time after the time when the configuration information is received and before the time when the instruction for activating MDT recording is received;

(3) a time when the configuration information is saved; and

(4) a time after the time when the configuration information is saved and before the time when the instruction for activating MDT recording is received.

For example, when the terminal receives configuration information delivered by a network node, the terminal saves the configuration information, and immediately starts the measurement timer. When the terminal is in the idle state or inactive state, if the terminal receives the instruction for activating MDT recording delivered by the network node, the instruction for activating MDT recording may be included in system information or a broadcast message. When the terminal receives the instruction for activating MDT recording, if the measurement timer does not expire, the terminal starts to perform MDT recording and saves the measurement result. It may be understood that a storage quantity or storage time of measurement results may be configured based on a specific situation.

In another embodiment of the present disclosure, after step 303, MDT recording can be stopped based on a preset condition. Optionally, the method may further include: stopping MDT measurement if the measurement timer expires; stopping MDT measurement if the terminal enters a connected state; and stopping MDT measurement and stopping the measurement timer if the terminal enters the connected state.

Step 304: Generate a measurement report according to the measurement result, and report at least part of content of the measurement report.

It should be noted that for descriptions of step 304, refer to the descriptions of step 204.

According to this embodiment of the present disclosure, a network can activate the terminal that is in the idle state or inactive state to perform MDT measurement.

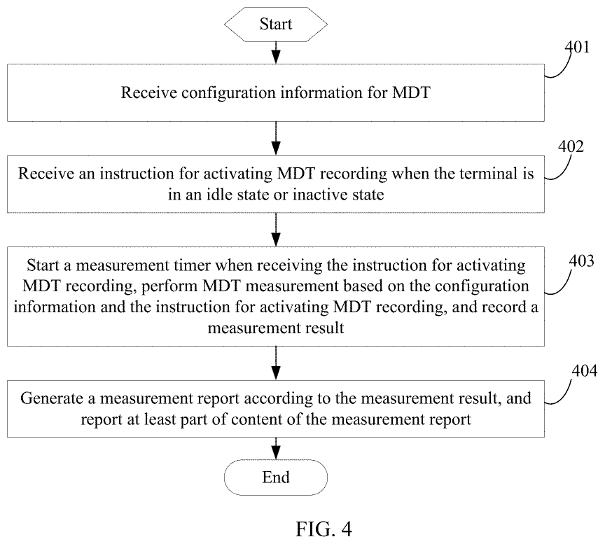

Referring to FIG. 4, an embodiment of the present disclosure further provides a measurement method. The method can be performed by a terminal, and the method includes steps 401 to 404.

Step 401: Receive configuration information for MDT.

It should be noted that for descriptions of step 401, refer to the descriptions of step 201.

Step 402: Receive an instruction for activating MDT recording when the terminal is in an idle state or inactive state.

It should be noted that for descriptions of step 402, refer to the descriptions of step 202.

Step 403: Start a measurement timer when receiving the instruction for activating MDT recording, perform MDT measurement based on the configuration information and the instruction for activating MDT recording, and record a measurement result.

For example, when the terminal is in the idle state or inactive state, if the terminal receives the instruction for activating MDT recording delivered by a network node, the instruction for activating MDT recording may be included in system information or a broadcast message. When the terminal receives the instruction for activating MDT recording, the terminal starts the measurement timer, and starts to perform MDT measurement and saves the measurement result. It may be understood that a storage quantity or storage time of measurement results may be configured based on a specific situation.

In another embodiment of the present disclosure, after step 403, MDT recording can be stopped based on a preset condition. Optionally, the method may further include: stopping MDT measurement if the measurement timer expires; stopping MDT measurement if the terminal enters the connected state; and stopping MDT measurement and stopping the measurement timer if the terminal enters the connected state.

Step 404: Generate a measurement report according to the measurement result, and report at least part of content of the measurement report.

It should be noted that for descriptions of step 404, refer to the descriptions of step 204.

According to this embodiment of the present disclosure, the network can activate the terminal that is in the idle state or inactive state to perform MDT measurement.

This embodiment of the present disclosure further provides a terminal. A principle of solving a problem by the terminal is similar to that of the measurement method in the embodiment of the present disclosure. Therefore, for implementation of the terminal, reference may be made to the implementation of the method, and details are not repeated again.

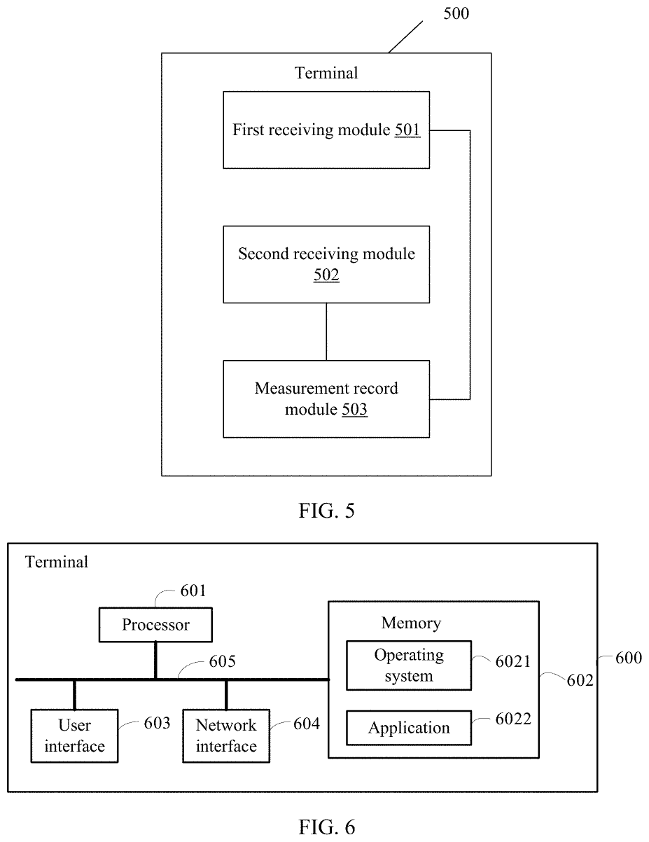

Referring to FIG. 5, an embodiment of the present disclosure further provides a terminal. The terminal 500 includes:

a first receiving module 501, configured to receive configuration information for MDT;

a second receiving module 502, configured to receive an instruction for activating MDT recording when the terminal is in an idle state or inactive state; and

a measurement record module 503, configured to perform MDT measurement based on the configuration information and the instruction for activating MDT recording, and record a measurement result.

In this embodiment of the present disclosure, optionally, the measurement record module 503 is further configured to: if a measurement timer does not expire, perform MDT measurement based on the configuration information and the received instruction for activating MDT recording, and record a measurement result.

In this embodiment of the present disclosure, optionally, a starting time of the measurement timer is at least one of the following:

a time when the configuration information is received;

a time after the time when the configuration information is received and before the time when the instruction for activating MDT recording is received;

a time when the configuration information is saved; and

a time after the time when the configuration information is saved and before the time when the instruction for activating MDT recording is received.

In this embodiment of the present disclosure, optionally, the measurement record module 503 is further configured to: start the measurement timer when receiving the instruction for activating MDT recording.

In this embodiment of the present disclosure, optionally, the measurement record module 503 is further configured to perform any one of the following:

stopping MDT measurement if the measurement timer expires;

stopping MDT measurement if the terminal enters a connected state; and

stopping MDT measurement and stopping the measurement timer if the terminal enters a connected state.

In this embodiment of the present disclosure, optionally, the second receiving module 502 is further configured to: receive system information or a broadcast message, where the system information or broadcast message includes the instruction for activating MDT recording.

In this embodiment of the present disclosure, optionally, the terminal further includes: a reporting module, configured to generate a measurement report according to the measurement result, and report at least part of the content of the measurement report.

In this embodiment of the present disclosure, optionally, the reporting module is further configured to: send first information to a network side, where the first information is used to indicate that the terminal has the measurement report; receive second information from the network side, where the second information is used to instruct the terminal to report at least part of the content of the measurement report; and report at least part of the content of the measurement report to the network side according to the second information.

In this embodiment of the present disclosure, optionally, the configuration information includes one or more of the following:

a measurement area parameter;

to-be-recorded measurement record content; and

a measurement timer.

In this embodiment of the present disclosure, optionally, the measurement area parameter includes one or more of the following:

a network slice list;

a RAN paging area;

a RAN notification area;

a RAN location area;

a system message effective area; and

information about a network cell.

In this embodiment of the present disclosure, optionally, the measurement record content includes one or more of the following:

an RSRP value of the SS block;

an RSRQ value of the SS block;

an SINR value of the SS block;

a measurement result of a PSS of the SS block;

a measurement result of an SSS of the SS block;

a measurement result of a PBCH of the SS block;

an RSRP value of a CSI-RS;

an RSRQ value of the CSI-RS;

an SINR value of the CSI-RS;

a measurement result of a TRS; and

a measurement result of a PTRS.

In this embodiment of the present disclosure, optionally, the measurement result of the PSS or the measurement result of the SSS includes a beam time index.

In this embodiment of the present disclosure, optionally, the measurement result of the PBCH includes one or more of the following:

a measurement result of a DMRS; and

beam information related to the DMRS.

The terminal provided in this embodiment of the present disclosure may perform the foregoing method embodiment. An implementation principle and a technical effect of the terminal are similar to those of the method embodiment, and details are not described again in this embodiment.

As shown in FIG. 6, a terminal 600 shown in FIG. 6 includes: at least one processor 601, a memory 602, at least one network interface 604, and a user interface 603. All components of the terminal 600 are coupled by using the bus system 605. It may be understood that the bus system 605 is configured to implement a connection and communication between these components. In addition to a data bus, the bus system 605 may include a power bus, a control bus, and a status signal bus. However, for clarity of description, various buses are marked as the bus system 605 in FIG. 6.

The user interface 603 may include a display, a keyboard, or a clicking device, for example, a mouse, a trackball (trackball), a touch panel, or a touchscreen.

It may be understood that the memory 602 in this embodiment of the present disclosure may be a volatile memory or a nonvolatile memory, or may include both a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. By way of example instead of limitation, many forms of RAM are available, such as a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 602 in the system and the method that are described in this embodiment of the present disclosure is to include but is not limited to these memories and a memory of any other proper type.

In some implementations, the memory 602 stores the following element: an executable module or a data structure, a subset of an executable module or a data structure, or an extended set of an executable module or a data structure: an operating system 6021 and an application program 6022.

The operating system 6021 includes various system programs, for example, a framework layer, a kernel library layer, and a driver layer, and is configured to implement various basic services and process hardware-based tasks. The application program 6022 includes various application programs, for example, a media player and a browser, and is configured to implement various application services. A program for implementing the method in the embodiments of the present disclosure may be included in the application program 6022.

In this embodiment of the present disclosure, when executed, a program or instruction stored in the memory 602, which may be specifically a program or instruction stored in the application program 6022, implements the following steps: receiving configuration information for MDT; receiving an instruction for activating MDT recording when the terminal is in an idle state or inactive state; and performing MDT measurement based on the configuration information and the instruction for activating MDT recording, and recording a measurement result.

The terminal provided in this embodiment of the present disclosure may perform the foregoing method embodiment. An implementation principle and a technical effect of the terminal are similar to those of the method embodiment, and details are not described again in this embodiment.

The method or algorithm steps described in combination with content disclosed in the present disclosure may be implemented by hardware, or may be implemented by a processor by executing software instructions. The software instruction may be formed by a corresponding software module. The software module may be stored in a RAM, a flash memory, a ROM, an EPROM, an EEPROM, a register, a hard disk, a removable hard disk, a read-only compact disc, or a storage medium of any other form known in the art. For example, a storage medium is coupled to the processor, so that the processor can read information from the storage medium or write information into the storage medium. Certainly, the storage medium may be a component of the processor. The processor and the storage medium may be located in the application specific integrated circuit (ASIC). In addition, the ASIC may be located in a core network interface device. Certainly, the processor and the storage medium may exist in the core network interface device as discrete components.

A person skilled in the art should be aware that in the foregoing one or more examples, functions described in the present disclosure may be implemented by hardware, software, firmware, or any combination thereof. When implemented by software, the foregoing functions may be stored in a computer readable medium or transmitted as one or more instructions or code in the computer readable medium. The computer readable medium includes a computer storage medium and a communications medium, where the communications medium includes any medium that enables a computer program to be transmitted from one place to another. The storage medium may be any available medium accessible to a general-purpose or dedicated computer.

The objectives, technical solutions, and beneficial effects of the present disclosure are further described in detail in the foregoing specific embodiments. It should be understood that the foregoing descriptions are merely specific implementations of the present disclosure, but are not intended to limit the protection scope of the present disclosure. Any modification, equivalent replacement, improvement, or the like made on a basis of the technical solutions of the present disclosure shall fall within the protection scope of the present disclosure.

A person skilled in the art should understand that the embodiments of the present disclosure may be provided as a method, a system, or a computer program product. Therefore, the embodiments of the present disclosure may be complete hardware embodiments, complete software embodiments, or software-hardware combined embodiments. Moreover, the embodiments of the present disclosure may use a form of a computer program product that is implemented on one or more computer-usable storage media (including but not limited to a magnetic disk memory, a CD-ROM, an optical memory, and the like) that include computer-usable program code.

The embodiments of the present disclosure are described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

Those computer program instructions can also be stored in a computer readable memory that can guide a computer or another programmable data processing device to work in a specific manner, so that the instructions stored in the computer readable memory generate a product including an instruction apparatus. The instruction apparatus implements functions specified in one or more procedures of a flowchart and/or one or more blocks of a block diagram.

These computer program instructions may also be loaded onto a computer or another programmable data processing device, so that a series of operation steps are performed on the computer or the another programmable device to produce computer-implemented processing, thereby providing instructions executed on the computer or the another programmable device to implement the function specified in one or more processes of the flowchart and/or one or more blocks of the block diagram.

Obviously, a person skilled in the art can make various modifications and variations to the embodiments of the present disclosure without departing from the spirit and scope of the present disclosure. In this way, the present disclosure is intended to include these modifications and variations of the embodiments of the present disclosure provided that they fall within the scope of the claims of the present disclosure and their equivalent technologies.

What is claimed is:

1. A measurement method, applied to a terminal and comprising:
receiving configuration information for minimization of drive-test (MDT);
receiving an instruction for activating MDT recording when the terminal is in an idle state or inactive state; and
performing MDT measurement based on the configuration information and the instruction for activating MDT recording, and recording a measurement result.

2. The measurement method according to claim 1, wherein performing the MDT measurement based on the configuration information and the instruction for activating MDT recording, and recording the measurement result comprises:
if a measurement timer does not expire, performing the MDT measurement based on the configuration information and the received instruction for activating MDT recording, and recording the measurement result.

3. The measurement method according to claim 2, wherein a starting time of the measurement timer is at least one of the following:
a time when the configuration information is received;
a time after the time when the configuration information is received and before a time when the instruction for activating MDT recording is received;
a time when the configuration information is saved; and
a time after the time when the configuration information is saved and before the time when the instruction for activating MDT recording is received.

4. The measurement method according to claim 1, further comprising:
starting a measurement timer when receiving the instruction for activating MDT recording.

5. The measurement method according to claim 1, wherein, after performing the MDT measurement based on the configuration information and the instruction for activating MDT recording, and recording the measurement result, the method further comprises any one of the following:
stopping MDT measurement if a measurement timer expires;
stopping MDT measurement if the terminal enters a connected state; and
stopping MDT measurement and stopping the measurement timer if the terminal enters the connected state.

6. The measurement method according to claim 1, wherein receiving the instruction for activating MDT recording comprises:
receiving system information or a broadcast message, wherein the system information or broadcast message comprises the instruction for activating MDT recording.

7. The measurement method according to claim 1, wherein after performing the MDT measurement based on the configuration information and the instruction for activating MDT recording, and recording the measurement result, the method further comprises:
generating a measurement report according to the measurement result, and reporting at least part of content of the measurement report.

8. The measurement method according to claim 7, wherein reporting the at least part of the content of the measurement report comprises:
sending first information to a network side, wherein the first information is used to indicate that the terminal has the measurement report;
receiving second information from the network side, wherein the second information is used to instruct the terminal to report the at least part of the content of the measurement report; and
reporting the at least part of the content of the measurement report to the network side according to the second information.

9. The measurement method according to claim 1, wherein the configuration information comprises one or more of the following:
a measurement area parameter;
to-be-recorded measurement record content; and
a measurement timer.

10. The measurement method according to claim 9, wherein the measurement area parameter comprises one or more of the following:
a network slice list;
a radio access network (RAN) paging area;
a RAN notification area;
a RAN location area;
a system message effective area; and
information about a network cell.

11. The measurement method according to claim 9, wherein the measurement record content comprises one or more of the following:
a reference signal received power (RSRP) value of a synchronization signal and physical broadcast channel (PBCH) block (SS block);
a reference signal received quality (RSRQ) value of the SS block;
a signal to interference plus noise ratio (SINR) value of the SS block;
a measurement result of a primary synchronization signal (PSS) of the SS block;
a measurement result of a secondary synchronization signal (SSS) of the SS block;
a measurement result of a PBCH of the SS block;
an RSRP value of a channel state information reference signal (CSI-RS);
an RSRQ value of the CSI-RS;
an SINR value of the CSI-RS;
a measurement result of a tracking RS (TRS); and
a measurement result of a phase-tracking RS (PTRS).

12. The measurement method according to claim 11, wherein the measurement result of the PSS or the measurement result of the SSS comprises a beam time index.

13. The measurement method according to claim 11, wherein the measurement result of the PBCH comprises one or more of the following:
a measurement result of a demodulation reference signal (DMRS); and
beam information related to the DMRS.

14. A terminal, comprising a processor, a memory, and a program stored in the memory and executable on the processor, wherein the program, when executed by the processor, causes the processor to implement a measurement method, the method comprising:
receiving configuration information for minimization of drive-test (MDT);
receiving an instruction for activating MDT recording when the terminal is in an idle state or inactive state; and
performing MDT measurement based on the configuration information and the instruction for activating MDT recording, and recording a measurement result.

15. The terminal according to claim 14, wherein performing the MDT measurement based on the configuration information and the instruction for activating MDT recording, and recording the measurement result comprises:
if a measurement timer does not expire, performing the MDT measurement based on the configuration information and the received instruction for activating MDT recording, and recording the measurement result.

16. The terminal according to claim 15, wherein a starting time of the measurement timer is at least one of the following:
a time when the configuration information is received;
a time after the time when the configuration information is received and before a time when the instruction for activating MDT recording is received;
a time when the configuration information is saved; and
a time after the time when the configuration information is saved and before the time when the instruction for activating MDT recording is received.

17. The terminal according to claim 14, wherein the method further comprises:
starting a measurement timer when receiving the instruction for activating MDT recording.

18. The terminal according to claim 14, wherein, after performing the MDT measurement based on the configuration information and the instruction for activating MDT recording, and recording the measurement result, the method further comprises any one of the following:
stopping MDT measurement if a measurement timer expires;
stopping MDT measurement if the terminal enters a connected state; and
stopping MDT measurement and stopping the measurement timer if the terminal enters the connected state.

19. The terminal according to claim 14, wherein receiving the instruction for activating MDT recording comprises:
receiving system information or a broadcast message, wherein the system information or broadcast message comprises the instruction for activating MDT recording.

20. A computer-readable storage medium, storing a computer program that, when executed by a processor, causes the processor to implement a measurement method, the method being applied to a terminal and comprising:
receiving configuration information for minimization of drive-test (MDT);
receiving an instruction for activating MDT recording when the terminal is in an idle state or inactive state; and
performing MDT measurement based on the configuration information and the instruction for activating MDT recording, and recording a measurement result.
